(19) United States
(12) Patent Application Publication
(10) Pub. No.: US 2006/0023047 A1
(43) Pub. Date: Feb. 2, 2006

(54) Methods and system for identifying a print medium in a consumables cartridge having a pre-printed border thereon

(76) Inventor: James Green, Brush Prarie, WA (US)

Correspondence Address: HEWLETT-PACKARD COMPANY;Intellectual Property Administration, P.O. Box 272400, Fort Collins, CO, 80527-2400, US

(21) Appl. No.: 10/909,216

(22) Filed: Jul. 30, 2004

(51) Int. Cl. B41J 2/01

(52) U.S. Cl. 347/104

(57) ABSTRACT

A consumables cartridge having a supply of a print medium having a pre-printed border, and an identification identifying the print medium with the pre-printed border, where the identification is readable by a printing device in which the consumables cartridge is installed.

### BACKGROUND

With a computer and printer, documents of all varieties can be readily produced by individual users, small enterprises and large companies. Typically, a host computer is used to generate or store an electronic version of a document. An application executing on the host, known as a printer driver, then converts the electronic version of the document into a data set that can be transmitted to and executed by a printer or printing device to produce the desired hardcopy. This data set is typically referred to as a print job.

Typically, the application used to generate the electronic version of the document can format the document for any of a variety of different print media. For example, the user can typically indicate whether the document should be formatted for a letter-size print medium, an A4 print medium, an envelope, etc. The user can also decide whether to layout the document in portrait or landscape orientation and make other decisions about how the document should be arranged when printed.

This typically works well as long as the print medium is exactly as expected. In some instances, a specialized print medium may have pre-printed elements already provided thereon. For example, the pre-printed medium may have a border printed around some or all of its edges. Such a border may reduce the area available for printing by the end user. Consequently, if this has not been taken into account as the document is created and laid out, when the document is printed, portions of the document may be printed over the pre-printed border on the print medium.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is an exploded illustration of a consumable cartridge for a printing device including a supply of a print medium, a supply of ink and a print head.

FIG. 2 is an illustration of the cartridge of FIG. 1 in an assembled state.

FIG. 3 is an illustration of a system including a host computer and a printing device using the cartridge of FIG. 2.

FIG. 4 is a block diagram of the principal internal components of one embodiment of the printing device and cartridge of FIG. 3.

FIG. 5 is a flowchart illustrating a method of operating the printing device of FIG. 4.

FIG. 6 is a block diagram of the principal internal components of another embodiment of the printing device and cartridge of FIG. 3.

FIG. 7 is a flowchart illustrating a method of operating the printing device of FIG. 6.

Throughout the drawings, identical reference numbers designate similar, but not necessarily identical, elements.

### DETAILED DESCRIPTION

As will be explained herein, a printer or printing device can be configured to automatically identify whether a pre-printed border exists around one or more edges of a supply of a print medium provided. If a pre-printed border or other pre-printed elements exist on the print medium, the printer or printing device is programmed to look up stored parameters defining the pre-printed elements and then automatically crop or resize the image of an incoming print job to fit within the pre-printed border or elements on the print medium.

As used herein, a “printing device” shall be understood to mean any device that generates a hardcopy of a document. Thus, a printing device may be, for example, an inkjet printer, a laser printer, a fax machine, a copy machine, etc. The term “ink” shall be understood to mean any material used by a printing device to mark a print medium to form a desired image on that medium. Thus, the term “ink” includes, for example, ink, toner, colorant, marking fluid, etc. The term “print medium,” plural “print media,” shall be understood to mean any medium on which a printing device selectively places ink to form a desired image including, for example, paper, envelopes, cardstock, vinyl, etc.

As used herein, the term “border” shall generally refer to elements disposed near part or all of one or more edges of a print medium. However, the principles described herein may be applied to any pre-printed elements located anywhere on the print medium. Therefore, the term “border” as used herein and in the appended claims shall be understood to refer to any pre-printed feature or element(s) no matter where located on the print medium and “border parameters” will be understood as data defining the location and shape of those pre-printed elements on the print medium.

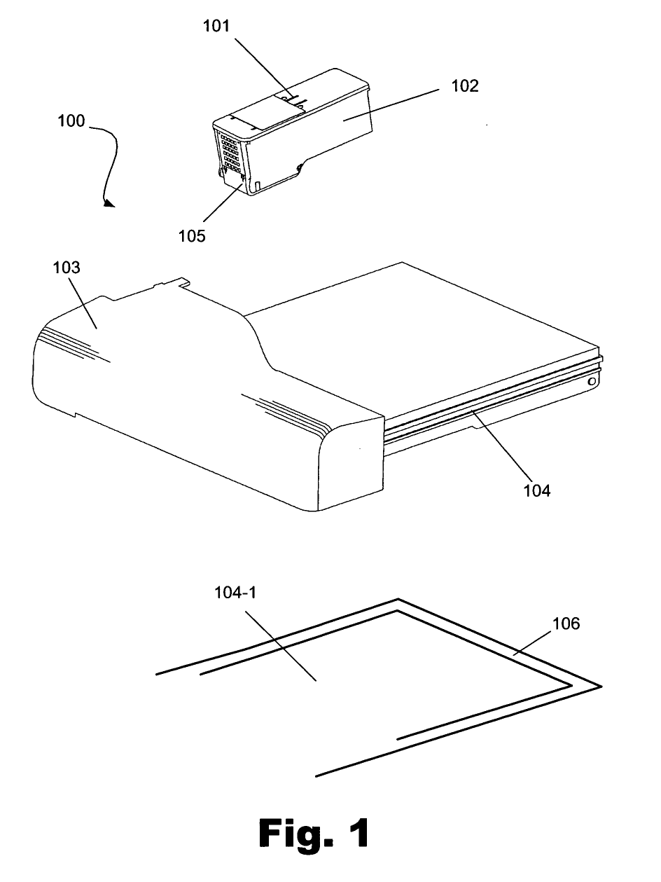

FIG. 1 is an exploded illustration of a consumable cartridge for a printing device. As used herein, a “consumable” is anything used or consumed by a printing device to generate a hardcopy product. According to FIG. 1, various consumables needed by a printing device can be combined into a single replaceable cartridge that is inserted in and used by that printing device.

As shown in FIG. 1, a supply of a print medium (104), a pen (101) and a supply of ink (102) may be incorporated into a consumables cartridge (100) for use in a printing device. The cartridge (100) has a housing (103) that at least partially encloses the supply of print media (104) and the pen (101). The pen (101) includes a reservoir of ink (102) and a print head (105), for example, an inkjet print head. However, the reservoir of ink or a secondary reservoir may be disposed elsewhere in the cartridge (100).

Each sheet (104-1) of the print medium (104) may have a pre-printed border (106) thereon. Thus, a particular border (106) desired by the user is printed or otherwise rendered along one or more edges of each sheet in the supply of print media (104).

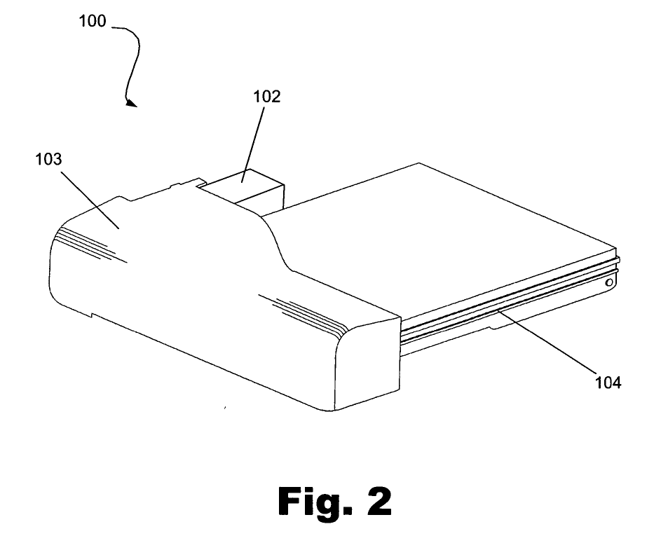

As will be described below, the printing device that uses the cartridge (100) will have some means of identifying the print media (104) in the cartridge (100), including parameters defining or describing the border (106). The printing device can then crop or resize the image to be printed on a sheet of that print medium (104) to fit within the border (106). FIG. 2 is an illustration of the cartridge of FIG. 1 in an unexploded state.

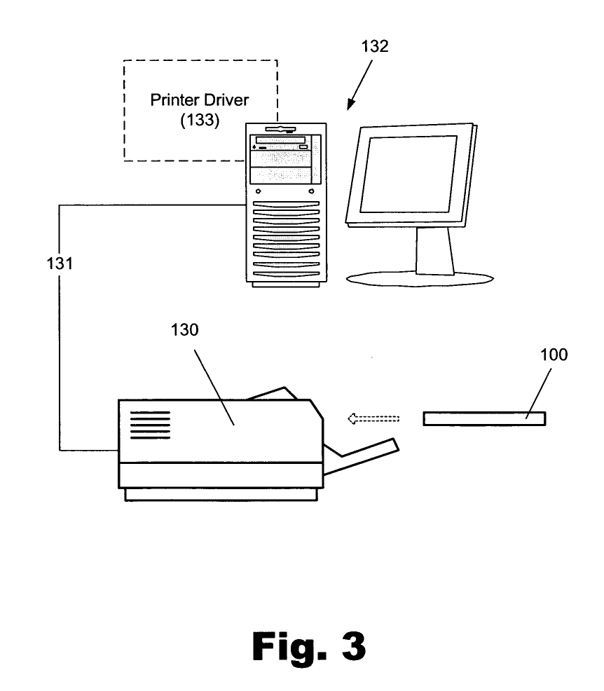

FIG. 3 is an illustration of a system including a host computer and a printing device using the cartridge of FIG. 2. As shown in FIG. 3, the host computer (132) is connected to the printing device (130). The connection (131) between the host computer (132) and the printing device (130) may be a direct connection or may include a network such as a Local Area Network (LAN), Wide Area Network (WAN), a wireless network, the Internet, etc.

The host computer (132) has a printer driver (133) that is installed and can be executed on the host computer (132). When an electronic document is to be printed, the printer driver (133) takes the electronic version of the document stored on the host computer (132) and generates a print job for that document. The print job is an electronic data set that can be used by the printing device (130) to print the desired document in hardcopy form.

The printing device (130) receives the print job over the connection (131) with the host computer (132). The printing device (130) then uses a supplied print medium and selectively places ink on the print medium in accordance with the data of the print job so as to form the desired image on the print medium.

The ink and the print medium may be supplied to the printing device (130) in the consumables cartridge (100), which was described and illustrated in more detail above. As shown in FIG. 3, the cartridge (100) is received in the printing device (130) to provide the printing device (130) with the ink, pen and print medium used to produce a hardcopy product based on a print job.

As described above, the print media in the cartridge (100) may have a pre-printed border. However, it is unlikely that the size and shape of the border, or even the existence of the border, will be taken into account when the electronic version of the document is generated. Unless the user specifically designs the document with the border in mind and then supplies the print media with the corresponding pre-printed border, it is possible or even likely that portions of the document will be printed on or over the pre-printed border.

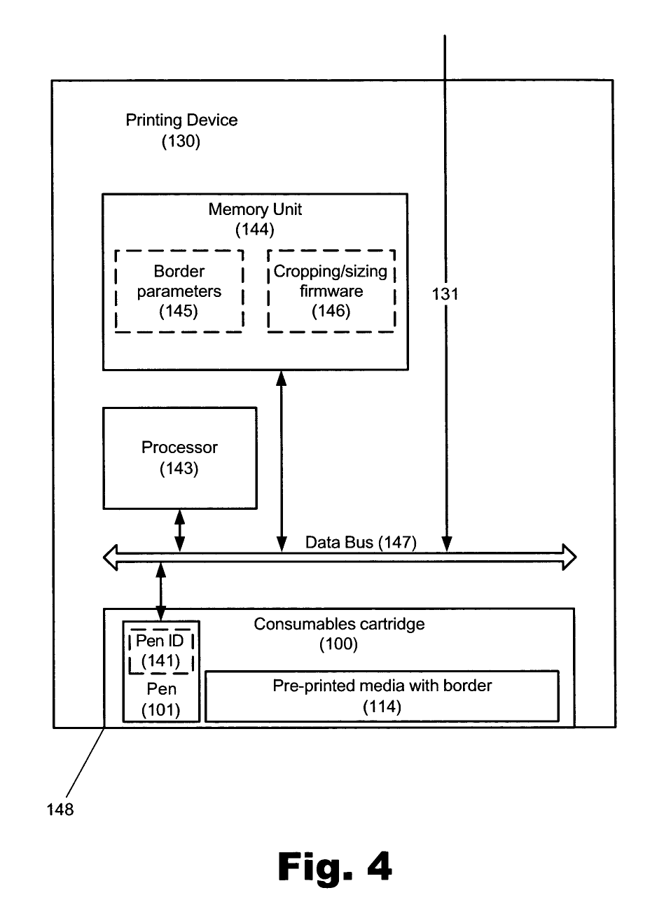

FIG. 4 is a block diagram of the principal internal components of one embodiment of the printing device and cartridge of FIG. 3. As shown in FIG. 4, the consumables cartridge (100) is received in a port (148) of the printing device (130). The cartridge (100) includes, a supply of a print medium (114) on which is a pre-printed border, meaning that the border is printed or rendered on the print media before the print media is included in the consumables cartridge (100) or supplied to the printing device (130).

The cartridge (100) also includes a pen (101). As described above, the pen (101) includes a print head and a supply of ink. When the consumables cartridge (100) is installed in the printing device (130), the pen (101) will be electrically connected to the printing device (130) so that the printing device (130) can supply power to the pen (101) and drive the pen (101) to print a desired image based on an incoming print job.

As described above, the printing device (130) receives print jobs over a connection (131) with a host computer or a network. The incoming print job is processed by the processor (143) of the printing device (130) which then drives the pen (101) to print the desired image on the print medium (114). A data bus (147) may be used to provide communication among the various components of the printing device (130), such as the processor (143), pen (101), connection (131) and a memory unit (144).

The pen (101) also includes an electronic pen identification or “Pen ID” (141). This Pen ID (141) can be read from the pen (101) by the processor (143). Consequently, the Pen ID (141) can be used to identify the pen (101) as among different types of pens that might be included in the consumables cartridge (100).

Additionally, some or all of the Pen ID can be used to identify the print media (114) that is included in the cartridge (100) with the pen (101). Thus, when the processor (143) reads the Pen ID (141) from the pen (101), the processor (143) can determine information about the print media (114) included in the cartridge (100). For example, based on the Pen ID (141), the processor (143) can determine whether any pre-printed border is provided on the print media (114) and may then lookup parameters that define the location, size, shape, etc. of the pre-printed border.

The memory unit (144) of the printing device (130) stores a variety of border parameters (145) for the various borders that might be pre-printed on the print media (114) of various cartridges (100). These parameters describe the location, size, shape, etc. of the pre-printed border.

To minimize the memory needed, these parameters (145) may be stored algorithmically, for example, the description of the border may be stored as a list of selected “x, y” points that lie on the edge of the border. An interpolation algorithm is then used to determine the unlisted points.

Consequently, the processor (143) will read the Pen ID (141) from the pen (101) when the cartridge (100) is installed in the printing device (130). The processor (143) will then match the Pen ID (141) or a portion of the Pen ID (141) with a corresponding set of border parameters from the database of border parameters (145) stored in the memory unit (144) of the printing device (130). Thus, the printing device (130) becomes aware of the existence, size, shape and location of the pre-printed border, if any, on the print media (114) in the consumables cartridge (100).

When a print job is received over the connection (131), the processor (143) can adjust the print job to account for the presence of the border on the print media (114). Logic, for example, in the form of firmware (146) may be installed in the memory unit (144) of the printing device (130) that can be executed by the processor (143) to either crop or resize the image of an incoming print job. As used herein, logic may include hardware, firmware, software, and/or any combination thereof. Firmware (146) and/or other like software, for example, can be configured to provide implementable instructions to the processor that are associated with performing one or more functions or acts.

As used herein, cropping an image refers to the process of deleting portions from one or more edges of the image. Thus, the processor (143) may use the border parameters that describe the pre-printed border on the print media (114) to determine whether any portion of the image described by the incoming print job will be rendered or printed on the pre-printed border. If so, those portions of the image are “cropped” or simply not printed when the print job is executed. Consequently, the printed image does not interfere with or impose on the pre-printed border.

In another alternative, the processor (143) may use the firmware (146) to resize or reduce the image described by the incoming print job so that the image is small enough to fit within the border on the pre-printed print medium (114). Using the parameters that describe the border, the processor (143) will be able to determine by what amount to reduce the incoming print image so that, when printed, the image fits within the pre-printed border.

The printing device may solicit user input to determine whether to crop or resize an incoming print job. This determination may be made for each print job or a default may be set that is used until changed.

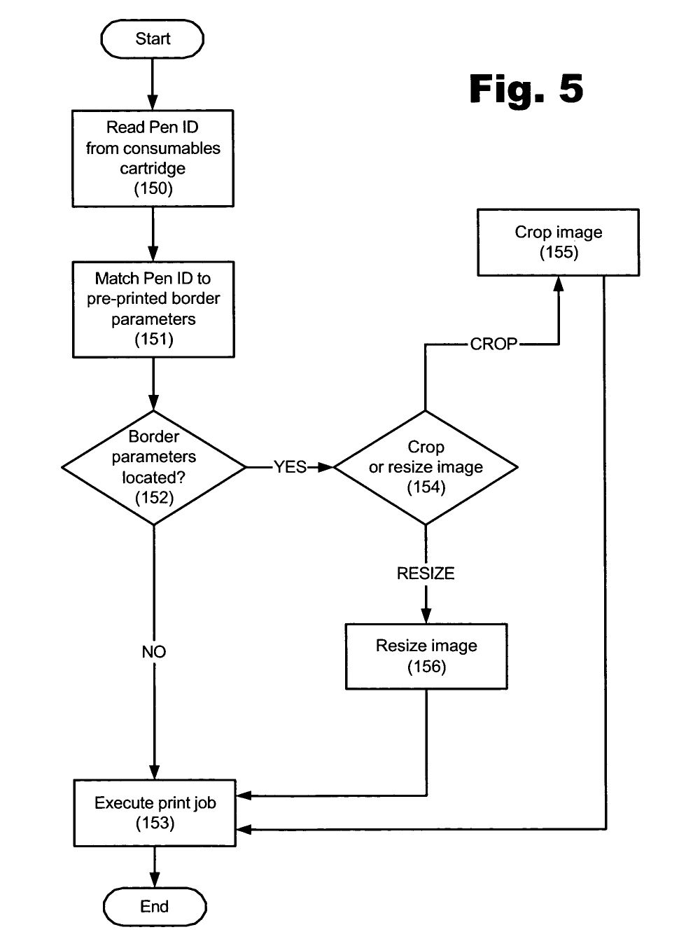

FIG. 5 is a flowchart illustrating a method of operating the printing device of FIG. 4. As shown in FIG. 5, the Pen ID is first read from the pen in the consumables cartridge (step 150). Next, the Pen ID is used to identify that set of border parameters stored in the memory of the printing device that describe the border, if any, on the print media in the consumables cartridge (step 151).

If no border parameters are located (determination 152), the printing device can assume that that print media in the consumables cartridge does not bear a pre-printed border. Accordingly, the print job is executed without any adjustment for a pre-printed border (step 153).

If, however, border parameters are located that correspond to the Pen ID read from the consumables cartridge (determination 152), those parameters can be used to either crop or resize the image of the print job to fit within the pre-printed border. The user may be prompted to input whether the print job should be cropped or resized (determination 154). Alternatively, a default may be set so that all print jobs are either cropped or resized to avoid the pre-printed border until the default setting is adjusted.

The image is then cropped (step 155) or resized (step 156) to fit within the borders on the pre-printed print media. The print job is then executed (step 153). Consequently, none of the printed image interferes with or is imposed on the pre-printed border.

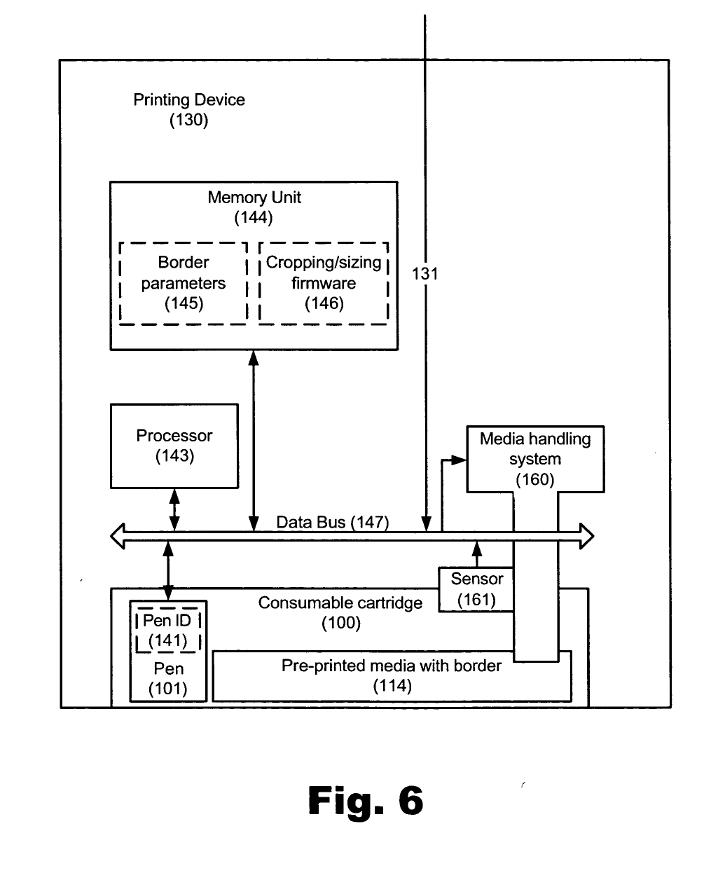

FIG. 6 is a block diagram of the principal internal components of another embodiment of the printing device and cartridge of FIG. 3. In addition to the components listed and described above with reference to FIG. 4, FIG. 6 illustrates a media handling system (160) that is part of the printing device (130). The media handling system feeds the print media from the consumable cartridge (100) through the printing device (130) as images are printed on the media.

Along with the media handling system (160) is a sensor (161). The sensor (161) can be any sensor capable of detecting the edge of a pre-printed border on a print medium. For example, the sensor (161) may be an optical sensor, such as a Charge Coupled Device (CCD). The sensor (161) is used to verify the existence and location of the pre-printed border on the print media (114) in a manner that will be described.

As sheets of print media are moved from the cartridge (100) and through the printing device (130) by the media handling system (160), the print media may become skewed or angled with respect to the print head or other components of the printing device (130). Consequently, the image printed on the print medium may be slightly angled with respect to the edges of the print medium. This skewing may result in some of the image being printed over the pre-printed border even though the image was cropped or resized to avoid the border.

To remedy this, the sensor (161) can be used to verify the location of the border as the print job is printed to avoid any printing on the pre-printed border. The sensor (161) may comprise an array of sensors aligned normal to the feed path of the print media or may be driven so as to translate across the feed path of the print media looking for the edge of the pre-printed border.

The border parameters (145) can be used to predict where the edge of the pre-printed border should be in the absence of any skewing. Thus, the search area in which the sensor (161) will search for the edge of the border can initially be centered on where the edge should be absent any skew and then increase outward from there as needed. This will minimize the time required to locate the edge of the border.

If the edge of the border is located by the sensor (161) at a different location than predicted by the border parameters (145), then the skew of the print media can be determined. Consequently, the processor (143) can adjust where the next swath of the image is printed so as to account for the skewing of the print media.

The sensor (161) can identify the location of the border edge and a skew adjustment can be made on each pass or swath of the pen (101). This, however, will significantly decrease the speed with which the printing device (130) can product a hardcopy product. Consequently, if maximum quality is not required, the sensor (161) may be used only periodically throughout the printing of the print job to determine the skew of the print media and allow an adjustment to be made so as to avoid the pre-printed border. For example, the sensor (161) may locate the edge of the pre-printed border only after the pen (101) has first made five or ten passes over the print medium.

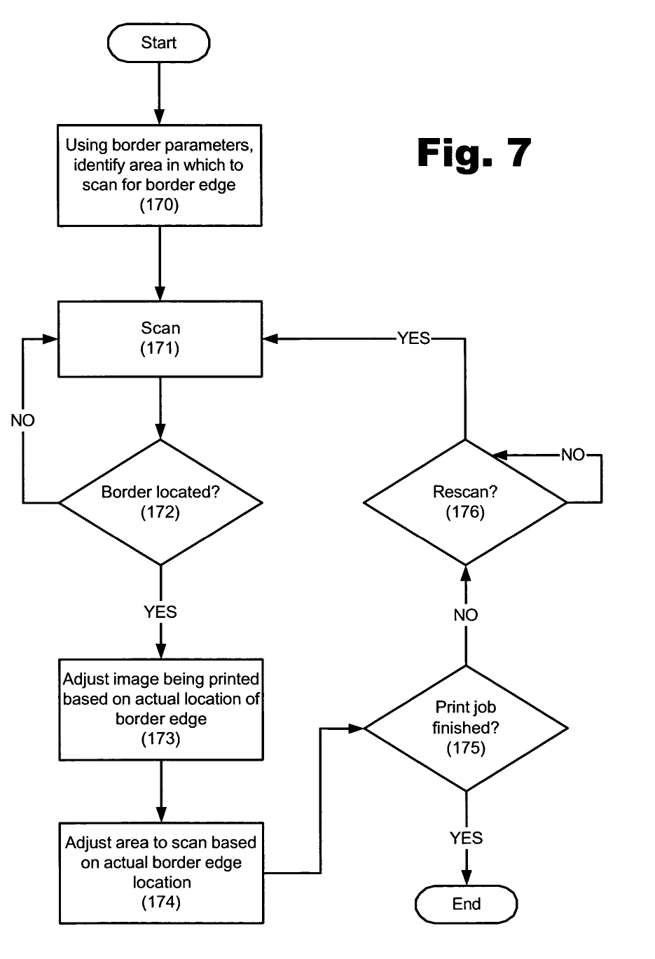

FIG. 7 is a flowchart illustrating a method of operating the printing device of FIG. 6. As shown in FIG. 7, the processor of the printing device will first use the border parameters identified as describing the pre-printed border on the supplied print media to predict where the edge of the border should be during some point in the execution of the print job (step 170). The processor will then operate the scanner to scan (step 171) for the edge of the border. To save time, the scan is started where the border is expected to be in the absence of any skewing and moves outward from that point.

If the border edge is not located (determination 172), the scan continues (step 171). When the border edge is located (determination 172), the processor determined whether any skewing is occurring and adjusts the printing of the image to account for the skewing, if any (step 173).

If skewing is detected, the processor can also use the skewing detected to predict where the edge of the border will be the next time the scanner is operated. By using the original border parameters, adjusted for the detected skew, the processor can readily determine where the border edge should be at some subsequent time in the execution of the print job. Consequently, the processor will start the scan (step 174) at the predicted location adjusted for skew the next time the scanner is operated. This further decreases the time required to use the scanner to compensate for skewing of the print medium.

If the print job is finished (determination 175), the process ends. However, if the print job is not finished (determination 175), the scanner will again be operated to verify the location of the border edge and adjust for any further skewing that occurs. Thus, the process will determine whether it is time for a subsequent scan (determination 176). As indicated above, scanning could take place with every pass of the pen over the print medium, but is more likely done at intervals during the execution of the print job. At an appropriate interval, another scan is performed (step 171) and the process repeats until the print job is completed (determination (175).

The preceding description has been presented only to illustrate and describe embodiments of the invention. It is not intended to be exhaustive or to limit the invention to any precise form disclosed. Many modifications and variations are possible in light of the above teaching. It is intended that the scope of the invention be defined by the following claims.

What is claimed is:

1. A consumables cartridge comprising:
a supply of a print medium having a pre-printed border; and
an identification identifying said print medium with said pre-printed border;
wherein said identification is readable by a printing device in which said consumables cartridge is installed.

2. The cartridge of claim 1, further comprising a pen with a Pen ID, wherein said identification comprises at least a portion of said Pen ID.

3. The cartridge of claim 2, further comprising a housing that at least partially encloses said supply of a print medium and said pen.

4. The cartridge of claim 1, further comprising a supply of ink.

5. A printing device comprising:
a port for receiving a removable consumables cartridge comprising a supply of a print medium having a pre-printed border, wherein said cartridge comprises an identification readable by said printing device; and
a memory unit storing border parameters describing said pre-printed border, said border parameters corresponding to said identification.

6. The printing device of claim 5, wherein said cartridge further comprises a pen having a Pen ID, and wherein said identification comprises at least a portion of said Pen ID.

7. The printing device of claim 5, further comprising a processor programmed to adjust a print job based on said border parameters so as to avoid printing on said pre-printed border.

8. The printing device of claim 7, wherein said processor crops said print job based on said border parameters so as to avoid printing on said pre-printed border.

9. The printing device of claim 7, wherein said processor resizes said print job based on said border parameters so as to avoid printing on said pre-printed border.

10. The printing device of claim 7, further comprising a sensor for locating an edge of said border on a piece of said print medium being printed.

11. The printing device of claim 10, wherein said processor is configured to adjust said print job based on an output from said sensor to compensate for feed skew of said piece of print medium.

12. A method of operating a printing device comprising:
receiving a removable consumables cartridge comprising a supply of a print medium having a pre-printed border;
reading an identification of said print medium in said cartridge; and
matching said identification with border parameters stored in a memory of said printing device, said border parameters describing said pre-printed border.

13. The method of claim 12, wherein said reading an identification comprises reading a Pen ID from a pen of said consumables cartridge.

14. The method of claim 12, further comprising adjusting a print job based on said border parameters so as to avoid printing on said pre-printed border.

15. The method of claim 14, wherein said adjusting said print job comprises cropping an image of said print job based on said border parameters so as to avoid printing on said pre-printed border.

16. The method of claim 14, wherein said adjusting said print job comprises resizing an image of said print job based on said border parameters so as to avoid printing on said pre-printed border.

17. The method of claim 16, wherein said resizing comprises reducing said image.

18. The method of claim 14, further comprising:
scanning a piece of print medium being printed to locate an edge of said border; and
further adjustng said print job based on said scanning to compensate for feed skew of said piece of print medium.

19. The method of claim 18, further comprising periodically repeating said scanning and said further adjusting of said print job to compensate for feed skew.

20. The method of claim 18, wherein said scanning comprises:
determining a location where said edge of said border should be absent feed skew of said piece of print medium; and
beginning said scanning at said location.

21. The method of claim 20, further comprising periodically repeating said scanning and said further adjusting of said print job to compensate for feed skew.

22. The method of claim 21, further comprising adjusting said location at which to begin said scanning based on detected feed skew.

23. A printing device comprising:
means for receiving a removable consumables cartridge comprising a supply of a print medium having a pre-printed border;
means for reading an identification of said print medium in said cartridge; and
means matching said identification with border parameters stored in a memory of said printing device, said border parameters describing said pre-printed border.

24. The system of claim 23, wherein said identification comprises a Pen ID from a pen of said consumables cartridge.

25. The system of claim 23, further comprising means for adjusting a print job based on said border parameters so as to avoid printing on said pre-printed border.

26. The system of claim 25, wherein said means for adjusting said print job comprise means for cropping an image of said print job based on said border parameters so as to avoid printing on said pre-printed border.

27. The system of claim 25, wherein said means for adjusting said print job comprise means for resizing an image of said print job based on said border parameters so as to avoid printing on said pre-printed border.

28. The system of claim 25, further comprising:
means for scanning a piece of print medium being printed to locate an edge of said border; and
means for further adjusting said print job based on said scanning to compensate for feed skew of said piece of print medium.

29. The system of claim 28, further comprising periodically repeating said scanning and said further adjusting of said print job to compensate for feed skew.

30. The system of claim 28, wherein said means for scanning comprise:
means for determining a location where said edge of said border should be absent feed skew of said piece of print medium; and
means for beginning said scanning at said location.

31. The system of claim 30, further comprising periodically repeating said scanning and said further adjusting of said print job to compensate for feed skew.

32. The system of claim 31, further comprising means for adjusting said location at which to begin said scanning based on detected feed skew.

33. Logic for use in a printing device that receives a removable consumables cartridge comprising a supply of a print medium having a pre-printed border, wherein said logic is configured to cause a processor of said printing device to perform acts comprising:
reading an identification of said print medium in said cartridge; and
matching said identification with border parameters stored in a memory of said printing device, said border parameters describing said pre-printed border.

34. The logic of claim 33, further comprising:
causing said processor to read a Pen ID from a pen of said consumables cartridge.

35. The logic of claim 33, further comprising:
causing said processor to adjust a print job based on said border parameters so as to avoid printing on said pre-printed border.

36. The logic of claim 35, further comprising:
causing said processor to crop an image of said print job based on said border parameters so as to avoid printing on said pre-printed border.

37. The logic of claim 35, further comprising:
causing said processor to reduce an image of said print job based on said border parameters so as to avoid printing on said pre-printed border.

38. The logic of claim 35, further comprising:
causing said processor to scan a piece of print medium being printed with a scanner to locate an edge of said border; and
further adjusting said print job based on said scan to compensate for feed skew of said piece of print medium.

39. The logic of claim 38, further comprising:
causing said processor to periodically repeat said scan and further adjust said print job to compensate for feed skew.

40. The logic of claim 38, further comprising:
causing said processor to determine a location where said edge of said border should be absent feed skew of said piece of print medium; and
beginning said scan at said location.

41. The logic of claim 40, further comprising:
causing said processor to periodically repeat said scan and further adjustment of said print job to compensate for feed skew.

42. The logic of claim 41, further comprising:
causing said processor to adjust said location at which to begin said scan based on detected feed skew.
